(19) United States
(12) Patent Application Publication
(10) Pub. No.: US 2016/0302100 A1
(43) Pub. Date: Oct. 13, 2016

(54) TECHNIQUES FOR RETRANSMISSIONS DURING BURSTY TRAFFIC

(71) Applicant: QUALCOMM Incorporated, San Diego, CA (US)

(72) Inventors: Sitaramanjaneyulu KANAMARLAPUDI, San Diego, CA (US); Sanjay Chacko VERGHESE, La Jolla, CA (US); Liangchi HSU, San Diego, CA (US); Amit Gopilal JAIN, San Diego, CA (US); Govind Ram VENKAT NARAYAN, San Diego, CA (US)

(21) Appl. No.: 15/001,009

(22) Filed: Jan. 19, 2016

Related U.S. Application Data
(60) Provisional application No. 62/145,389, filed on Apr. 9, 2015.

(51) Int. Cl. H04W 28/02; H04W 72/04; H04W 72/12; H04W 72/10; H04L 1/18

(52) U.S. Cl. CPC H04W 28/0252; H04W 72/10; H04L 1/1887; H04W 72/1242; H04W 72/0446

(57) ABSTRACT

The disclosure provides for a user equipment (UE) handling radio link control (RLC) reset in wireless communications. Various techniques are described wherein RLC reset procedures are associated with various triggering conditions and predetermined time periods at RLC. Delays for initiation and execution of the RLC reset procedures are also described. In an aspect, the UE determines that at least one data unit to be received over a first logical channel is yet to be received by the UE and that there is data traffic over a second logical channel with higher priority than the first logical channel. In another aspect, the UE delays initiation of an RLC reset on a condition that the UE determines that at least one data unit is yet to be received over the first logical channel and that there is data traffic over the second logical channel.

### CROSS-REFERENCE TO RELATED APPLICATION

This application claims the benefit of U.S. Provisional Application Ser. No. 62/145,389, entitled “ENHANCED RETRANSMISSION MECHANISM DURING BURSTY TRAFFIC” and filed on Apr. 9, 2015, which is expressly incorporated by reference herein in its entirety.

### BACKGROUND

The present disclosure relates generally to communication systems, and more particularly, to techniques for improving the performance of transmissions or retransmissions during bursty traffic in a wireless network.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

Another telecommunication standard is Long Term Evolution (LTE) which is a set of enhancements to the UMTS mobile standard promulgated by 3GPP. LTE is designed to support mobile broadband access through improved spectral efficiency, lowered costs, and improved services using OFDMA on the downlink, SC-FDMA on the uplink, and multiple-input multiple-output (MIMO) antenna technology. As the demand for mobile broadband access continues to increase, research and development continue to advance the UMTS technologies not only to meet the growing demand for mobile broadband access, but to advance and enhance the user experience with mobile communications.

Many aspects of the operation and behavior of a wireless communication network (also referred to as NW), and the user devices (also referred to as user equipment or UE) they support, may be defined in one or more Standard specifications, such as those issued by 3GPP. For example, 3GPP Radio Link Control (RLC) protocol specification (Technical Specification 25.322), section 11.4, outlines the conditions under which a transmitting entity may initiate an RLC reset procedure on a particular logical channel. One problem may occur, for example, in UMTS networks with the 3GPP guidelines, where data traffic from a radio bearer is prioritized for transmission based on associated logical channel priority and any other radio bearers associated with a lower channel priority have data (e.g., Control packet data units (PDUs) or Status PDUs) to be transmitted but may not be considered. The transmitting entity (e.g., an UE or a network device) may request a peer RLC entity for a status report by transmitting or retransmitting a data unit querying for status (e.g., a Data PDU with Polling Bit set, a Poll SUFI PDU, or a status request). If no acknowledgement in response to the transmitted or retransmitted data unit is received by the transmitting entity and the maximum number of transmissions of the data unit is reached, a reset may be initialed and may cause an interruption of communication, for example, a call drop. It may become critical if the dropped call is a 911 Emergency Call in a bursty traffic environment with, for example, inconsistent traffic levels, sudden traffic peaks/increases, or relatively high-bandwidth transmissions over a certain radio bearer. Therefore, improvements in handling of data transmissions and retransmissions during bursty or heavy traffic in a wireless network are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Various techniques are described wherein RLC reset procedures are associated with various triggering conditions and predetermined time periods at RLC. Delays for initiation and execution of the RLC reset procedures are also described.

In an aspect, a method includes a user equipment (UE) determining that at least one data unit to be received over a first logical channel is yet to be received by the UE. In an aspect, the method also includes the UE determining that there is on-going data traffic over a second logical channel, and the first logical channel has a lower priority than the second logical channel. In another aspect, the method also includes the UE delaying initiation of an RLC reset on a condition that the UE determines that the at least one data unit is yet to be received over the first logical channel and there is data traffic over the second logical channel.

In another aspect, an apparatus for wireless communications is provided. In an aspect, the apparatus includes means for determining that at least one data unit to be received over a first logical channel is yet to be received. In an aspect, the apparatus also includes means for determining that there is data traffic over a second logical channel, wherein the first logical channel having a lower priority than the second logical channel. In another aspect, the apparatus includes means for delaying initiation of an RLC reset on a condition that the at least one data unit is yet to be received over the first logical channel and there is data traffic over the second logical channel.

In an aspect, an apparatus for wireless communications is provided. The apparatus may include a memory configured to store instructions, and at least one processor coupled to the memory. In an aspect, the at least one processor and the memory are configured to determine that at least one data unit to be received over a first logical channel is yet to be received. In another aspect, the at least one processor and the memory are configured to determine that there is data traffic over a second logical channel, and the first logical channel having a lower priority than the second logical channel. In an aspect, the at least one processor and the memory are configured to delay initiation of an RLC reset on a condition that the at least one data unit is yet to be received over the first logical channel and there is data traffic over the second logical channel.

In an aspect, a computer-readable medium associated with at least one processor storing computer executable code for handling initiation of RLC reset procedures in wireless communications is provided. In an aspect, the computer-readable medium includes computer executable code to determine that at least one data unit to be received over a first logical channel is yet to be received. In another aspect, the computer-readable medium includes computer executable code to determine that there is data traffic over a second logical channel, and the first logical channel having a lower priority than the second logical channel. In an aspect, the computer-readable medium includes computer executable code to delay initiation of an RLC reset on a condition that the at least one data unit is yet to be received over the first logical channel and there is data traffic over the second logical channel.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 is a schematic diagram illustrating an example apparatus for managing RLC reset operations.

FIG. 2 is a flow chart of an aspect of a method for managing an RLC reset procedure as described herein;

FIG. 3A is a flow chart of an aspect of a method of triggering or delaying initiation of an RLC reset procedure as described herein;

FIG. 3B is a flow chart of another aspect of a method of triggering or delaying initiation of an RLC reset procedure as described herein; and

FIG. 4 is a flow chart of an example for delaying an RLC reset procedure using a delay timer as described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

When referred to hereafter, the terminology “user equipment” or “UE” includes but is not limited to a mobile station, a fixed or mobile subscriber unit, a pager, a cellular telephone, a personal digital assistant (PDA), a computer, or any other type of user device capable of operating in a wireless environment. When referred to hereafter, the terminology “wireless communication network” or “NW” includes but is not limited to a base station, a Node-B, an evolved Node-B, a site controller, an access point (AP), or any other type of interfacing device capable of operating in a wireless environment.

It should be noted that the disclosed RLC ‘Reset’ procedure may be referred to by other names such as RLC ‘Re-establishment’ or RLC ‘Re-configuration’. As such, the disclosed methods and apparatus applies even when the procedures proposed herein are described using other names or terms in the 3GPP standards specifications.

In an aspect, data traffic from a Radio Bearer is usually prioritized for transmission based on associated logical channel priority. If data (e.g., Control PDUs or Status PDUs) are scheduled to be transmitted on other radio bearers at a lower priority, the data may be missed or not be considered. A receiving entity (e.g., an UE or a network device) may keep transmitting requests for status. When the maximum number of times (e.g., MaxDAT) have been attempted on the lower priority logical channel, and no acknowledgement is received by the receiving entity, a RESET operation on Layer 2, for example, an RLC reset procedure may be initialed and may cause an interruption of communication and ultimately a call drop. It may become critical when the call in question is a 911 Emergency Call.

In another aspect, if a transmitter (e.g., a UE) has retransmitted a PDU querying for status (e.g., a Data PDU with Polling Bit set or a Poll SUFI PDU) for a number of times (e.g., MaxDAT) without receiving an acknowledgement (ACK) for the queried PDU or PDUs, a reset (e.g., an RLC reset) may be initiated to get the transmitting and receiving entities in synchronization.

In an aspect, at an RLC layer of Layer 2 in a wireless communication system, each Radio Bearer (RB) is mapped to a logical channel. Each mapped logical channel has a priority associated with it. As such, the RLC layer and a media access control (MAC) layer prioritize data from respective RBs for transmission. In UMTS, for example, a logical channel associated with Signaling Radio Bearer (SRB) 2 has a higher priority than that of SRB 3, and SRB 2 carries radio layer (e.g. RRC) messages, while SRB 3 carries non-radio layer (NAS layer or upper layer) messages.

In another aspect, UE may be expected to transmit PDUs among the RBs based on the priority of logical channels on which the RB is mapped. If SRB 2 has outstanding signaling Data PDUs to be transmitted in downlink (DL) while having a higher priority and SRB 3 has Control PDUs to be sent in DL while having a lower priority. As such, Data on SRB 2 may be prioritized over Control PDU on SRB 3. In case MaxDAT transmissions are reached, a reset may be initiated by the sender (e.g., a UE) on SRB 3 while the sender on SRB 3 is still waiting for an RLC ACK, which the NW was unable to send as it was transmitting higher priority data (e.g. for SRB2) in DL.

For example, RBs are configured such that SRB2 has a higher priority than SRB 3. SRB 3 has Non-Access Stratum (NAS) signaling on uplink (UL), sends PDUs to a wireless communication network (NW), and awaits an Acknowledgement (ACK) PDU from the NW in downlink (DL). Due to an on-going 911 call request, NW may need to query for information (e.g., UE positions or altitudes), which are needed based on, for example, cell towers and satellite related metrics. This information inquiry may result in a large number of Measurement Control PDUs on SRB 2 in DL and the associated size of each Measurement Control PDU may be very large. Due to the large amount of data to be sent in DL on SRB 2 with a higher priority, the ACK for SRB 3 in DL may still be pending transmission on the NW side. Meanwhile, SRB 3 at the UE may continually retransmit UL PDUs, on every poll timer expiry and may increase a state variable counter (e.g., VT (DAT)). When the state variable counter (e.g., retransmission counter, VT (DAT)) reaches the maximum threshold (e.g., MaxDAT) without receiving an ACK in DL, UE may initiate a reset (e.g., an RLC reset) on SRB 3. From Release 10 of Radio Resource Control (RRC) Specification 25.331, for example, the default configuration for the maximum number of transmissions of a RESET PDU is equal to MaxRST-1. MaxRST represents the upper limit for another state variable VT (RST), a reset state variable used to count the number of times a RESET PDU is scheduled to be transmitted before the reset procedure is completed. When VT (RST) equals the value MaxRST, unrecoverable error may be indicated to upper layers. Because the MaxRST for SRB 2 and SRB 3 is configured as “1”, a single RESET on these logical channels (e.g., SRB 2 and SRB 3) is sufficient to result in a Call Drop or a Call Release. As MaxRST for SRB 3 is limited to “1”, an RLC unrecoverable error may be indicated or delivered to upper layers (e.g., RRC). Due to this unrecoverable error report, a call may be dropped or fail at signaling level while NW is gathering UE information (e.g., location information) which is vital to serve an emergency call such as a 911 call.

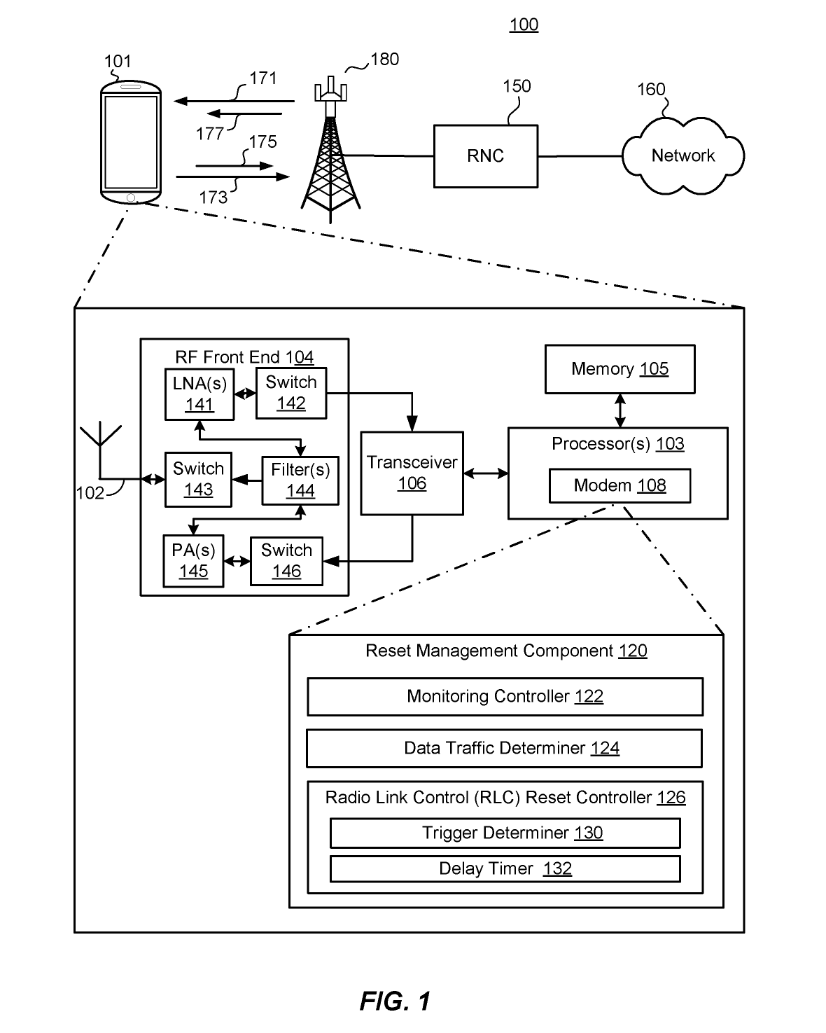

Referring to FIG. 1, in an aspect, a wireless communication system 100 includes UE 101 in communication coverage of a network entity 180 (e.g., a base station or a Node B). UE 101 may communicate with a network 160 via network entity 180 and a radio network control (RNC) 150. In an aspect, UE 101 may have established one or more uplink channels 173 for sending control (e.g., signaling) and/or data units 175 to network entity 180, and one or more downlink channels 171 for receiving control (e.g., signaling) and/or data units 177 via network entity 180. In an aspect, the data units 175 and data units 177 may be sent through signaling radio bearers (SRBs). For example, in an aspect, UE 101 and or network entity 180 may use SRBs in channels 171, 173 to sent signaling messages as data units 175 and 177. The signaling messages may include configuration information, PDUs, or acknowledgement (e.g., ACK) messages for UE 101 to make a decision as to whether to initiate or delay initiation of an RLC reset at a Reset Management Component 120 of the UE 101.

In an aspect, UE 101 may include RF front end 104 and transceiver 106 for receiving and transmitting radio transmissions, including, for example, the described signaling messages and also any messages corresponding to the operation of Reset Management Component 120. RF front end 104 may be connected to one or more antennas 102. RF front end 104 may include, for example, one or more low-noise amplifiers (LNAs) 141, one or more switches 142, 143, 146, one or more power amplifiers (PAs) 145, and one or more filters 144 for transmitting and receiving RF signals on the uplink channels 173 and downlink channels 171. RF front end 104 is merely an example configuration; in an aspect, other configurations for RF front end 104 can be used by UE 101. In an aspect, components of RF front end 104 can connect with transceiver 106. Transceiver 106 may connect to one or more processor 103.

In an aspect, LNA 141 can amplify a received signal at a desired output level. In an aspect, each LNA 141 may have a specified minimum and maximum gain values. In an aspect, RF front end 104 may use one or more switches 142, 143 to select a particular LNA 141 and its specified gain value based on a desired gain value for a particular application.

Further, for example, one or more PA(s) 145 may be used by RF front end 104 to amplify a signal for an RF output at a desired output power level. In an aspect, each PA 145 may have a specified minimum and maximum gain values. In an aspect, RF front end 104 may use one or more switches 143, 146 to select a particular PA 145 and its specified gain value based on a desired gain value for a particular application.

Also, for example, one or more filters 144 can be used by RF front end 104 to filter a received signal to obtain an input RF signal. Similarly, in an aspect, for example, a respective filter 144 can be used to filter an output from a respective PA 145 to produce an output signal for transmission. In an aspect, each filter 144 can be connected to a specific LNA 141 and/or PA 145. In an aspect, RF front end 104 can use one or more switches 142, 143, 146 to select a transmit or receive path using a specified filter 144, LNA, 141, and/or PA 145, based on a configuration as specified by transceiver 106 and/or processor 103.

In an aspect, UE 101 may include one or more processors 103 that may operate in combination with Reset Management Component 120 for handling initiation of RLC reset procedures as described herein. In an aspect, the one or more processors 103 may include a modem 108 that uses one or more modem processors. In another aspect, the one or more processors 103 may coupled to at least a memory 105, wherein the memory 105 may be configured to store instructions for handling initiation of RLC reset procedures.

Various functions related to Reset Management Component 120 may be included in modem 108 and/or one or more processors 103 and, in an aspect, may be executed by a single processor, while in other aspects, different ones of the functions may be executed by a combination of two or more different processors. For example, in an aspect, the one or more processors 103 may include any one or any combination of a modem processor, or a baseband processor, or a digital signal processor, or a transmit processor, or a transceiver processor associated with transceiver 106. In particular, the one or more processors 103 may execute functions included in Reset Management Component 120, including a monitoring controller 122 for monitoring or detecting data or signaling messages (e.g., a status PDU, an ACK PDU, or an acknowledgement message) being transmitted and/or received at UE 101, and a data traffic determiner 124 for making determinations that whether data or signaling messages are being sent from network entity 180 to UE 101, or being received by UE 101. In another aspect, the data traffic determiner 124 may identify the logic channel over which the data traffic is being scheduled for transmission or being transmitted. In addition, the data traffic determiner 124 may also identify the priority associated with each logic channel that is being used.

In an aspect, Reset Management Component 120 may include an RLC reset controller 126 for handling initiation and/or execution of RLC reset procedures. The RLC reset controller 126 may communicate with monitoring controller 122 and data traffic determiner 124 for handling initiation of RLC reset procedures. For example, after monitoring controller 122 detects data or signaling messages for UE 101, and data traffic determiner 124 determines that at least one data unit is to be received over a lower priority logical channel and there is on-going data traffic over a higher priority logical channel, the RLC reset controller 126 may delay initiation of an RLC reset. In particular, in an aspect, the RLC reset controller 126 may include a trigger determiner 130 and a delay timer 132. In an aspect, the trigger determiner 130 may be used for determining one or more triggering conditions and determining whether the one or more conditions may trigger an RLC reset initiation. For example, when monitoring controller 122 has not detected any downlink PDU being scheduled or transmitted to UE 101 within a predetermined time period, and data traffic determiner 124 makes a determination that no data or signaling messages are being sent from network entity 180 to UE 101 within the predetermined time period, the trigger determiner 130 may determine at least one triggering condition is met and initiate a trigger indication, and ultimately an RLC reset initiation may be triggered. In another example, when monitoring controller 122 has detected one or more downlink PDUs (e.g., data or control PDUs) being scheduled or transmitted to UE 101, and data traffic determiner 124 makes a determination that the one or more downlink PDUs are being sent from network entity 180 to UE 101 on a logical channel having a priority lower than another logical channel where the maximum number of transmissions/retransmissions of an uplink PDU have been attempted, the trigger determiner 130 may determine at least one triggering condition is met and initiate a trigger indication, and ultimately an RLC reset initiation may be triggered.

In another aspect, the trigger determiner 130 may be used for determining various triggering conditions and making a decision to whether a delay for initiating an RLC reset shall be applied. In an aspect, the various triggering conditions may be based on or associated with the determining results from data traffic determiner 124. For example, after monitoring controller 122 has detected one or more downlink PDUs being scheduled or transmitted to UE 101 within a predetermined time period, and data traffic determiner 124 makes a determination that there are on-going data traffic from network entity 180 to UE 101 within the predetermined time period, the trigger determiner 130 may determine that no triggering condition is met and an RLC reset initiation may be delayed. In another example, when monitoring controller 122 has detected one or more downlink PDUs (e.g., data or control PDUs) being scheduled or transmitted to UE 101, and data traffic determiner 124 makes a determination that there is no downlink PDUs being sent from network entity 180 to UE 101 on a logical channel having a priority equal or lower than another logical channel where the maximum number of transmissions/retransmissions of an uplink PDU have been attempted, the trigger determiner 130 may determine that no triggering condition is met and an RLC reset initiation may be delayed.

In another aspect, data traffic determiner 124 and trigger determiner 130 may be used as individual determiners or combined as one determiner for determining the data traffic conditions and triggering conditions. In an aspect, if the trigger determiner 130 determines that a condition is met for delaying an RLC reset, the delay timer 132 is configured to start or reset (e.g., set the delay timer to zero). The delay timer 132 may include or be configured to implement at least one of a predetermined time period, a state variable, a Last_Received_Timer, a counting timer, or any other type of component or module capable of counting or tracking time or times. In an aspect, the delay timer 132 may be set (e.g., an expiration value of the timer may be set) from zero to a couple of hundred milliseconds.

In another aspect, Reset Management Component 120 may include hardware and/or software code executable by processor 103 for handling initiation of RLC reset procedures that correspond to one or more UE configurations for UE 101 and for managing how and/or if the pending signaling messages are processed to ensure that UE 101 and network entity 180 are in sync with respect to the UE configuration for UE 101. Moreover, in an aspect, a component may be one of the parts that make up a system, may be hardware or software, and/or may be divided into other components.

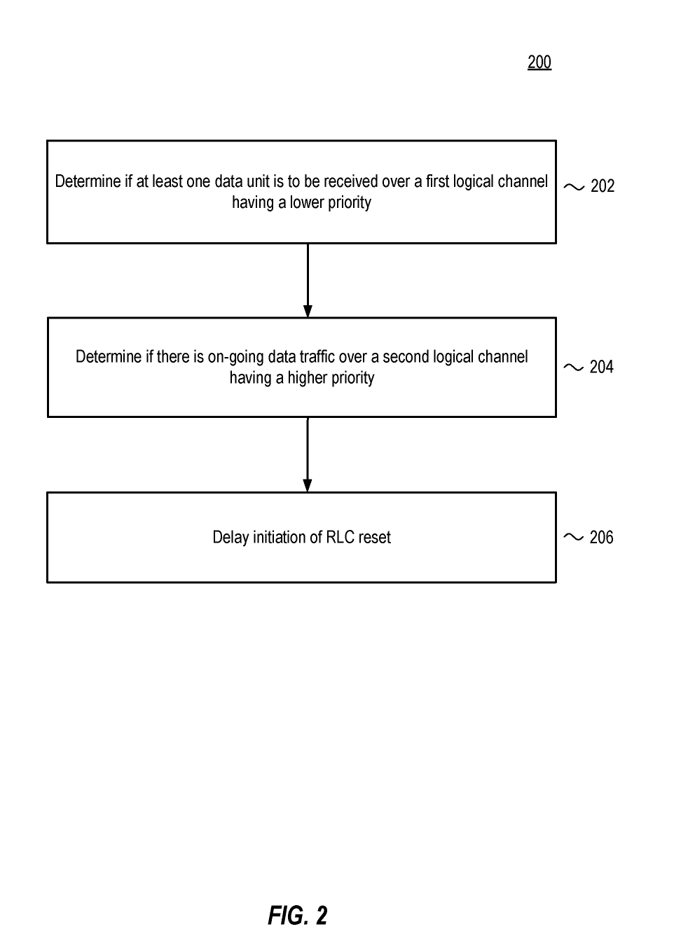

Referring to FIG. 2, in an operational aspect, a UE such as UE 101 (in FIG. 1) may perform one aspect of method 200 for determining certain conditions at UE 101 in order to avoid an unnecessary RLC reset. In an aspect, once UE 101 sends a first data unit to network entity 180, the monitoring controller 122 at UE 101 (in FIG. 1) may monitor or detect downlink channels to see whether there is a second data unit (e.g., an ACK) from network entity 180 in response to sending the first data unit. At block 202, method 200 may include determining that whether the second data unit (e.g., an ACK) to be received over a logical channel with a lower priority. For example, the data traffic determiner 124 of UE 101 may determine whether UE 101 is still waiting for the second data unit (e.g., an ACK or a PDU) to be delivered over the logical channel with lower priority in downlink by checking or detecting (e.g., via monitoring controller 122) whether the second data unit is received by transceiver 106.

At block 204, method 200 may include determining that whether there is on-going data traffic over another logical channel with a higher priority. For example, the data traffic determiner 124 may determine whether there is on-going data traffic over any logical channel. In addition, the data traffic determiner 124 may also identify that a first logical channel has a lower priority than a second logical channel. In an aspect, once the data traffic determiner 124 determines that there is continuous on-going traffic in DL on a higher priority logical channel (i.e., the second logical channel), and the data unit(s) (e.g., an ACK) on a lower priority logical channel (i.e., the first logical channel) which UE 101 is still waiting for is not yet received, the trigger determiner 130 of UE 101 determines that no triggering condition is met, even if the maximum number of transmissions (e.g., MaxDAT) have been attempted on the lower priority logical channel (i.e., the first logical channel). Then the delay timer 132 is configured in order to avoid initiating an RLC reset. Once the delay timer 132 is configured and starts, UE 101 may continue retransmitting PDUs in uplink (e.g., requesting the status from peer RLC layer in the NW).

As such, at block 206, method 200 may include delaying initiation of an RLC reset on a condition that the second data unit is yet to be received over the first logical channel and there is on-going data traffic over the second logical channel. For example, the RLC reset controller 126 may delay initiation of an RLC reset when the trigger determiner 130 of UE 101 determines that there is no triggering condition being met and no triggers have been initiated, based on the determinations from data traffic determiner 124 which are described at blocks 202 and 204.

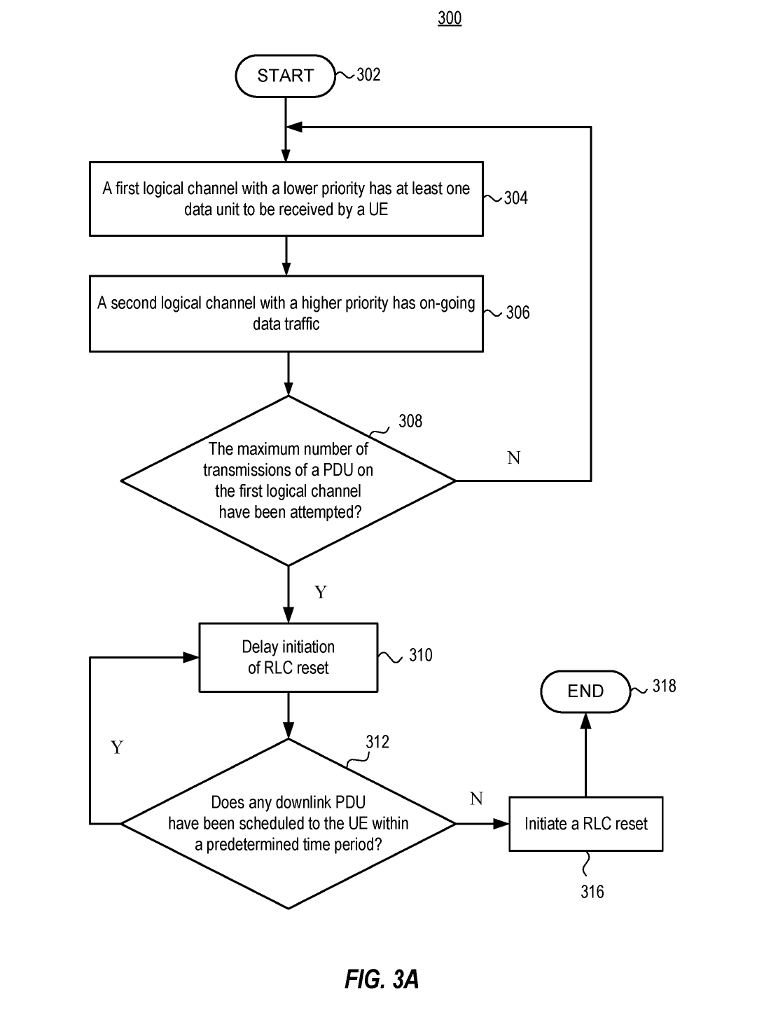

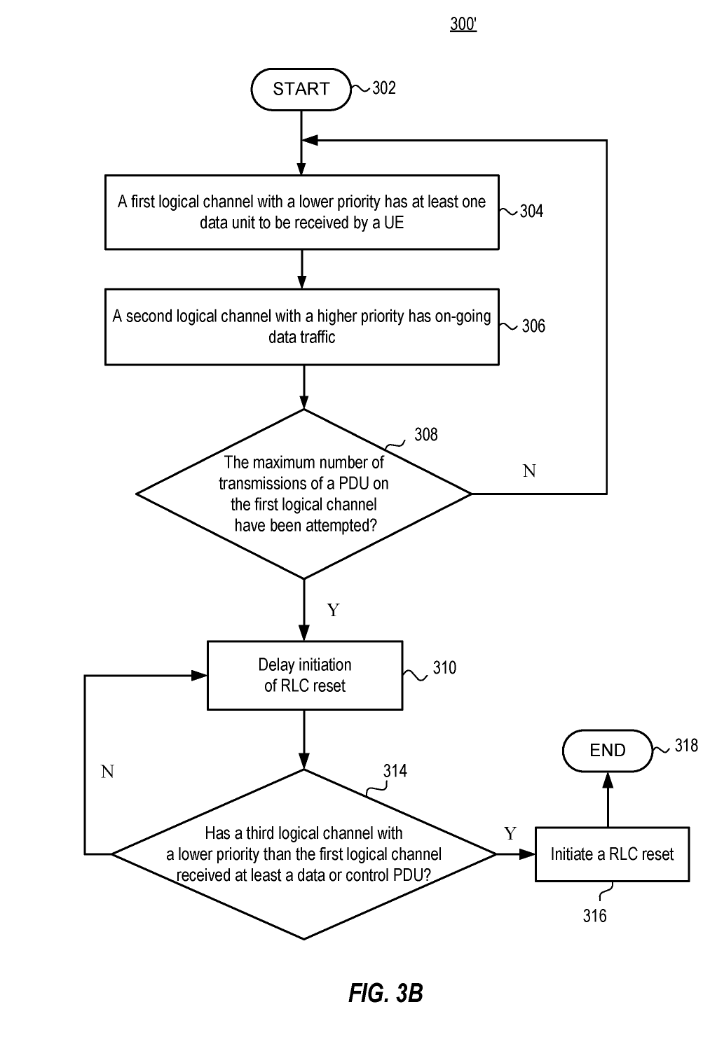

Referring to FIG. 3A, in an operational aspect, a UE such as UE 101 (in FIG. 1) may perform one aspect of method 300 for triggering or delaying of an RLC reset initiation. In an aspect, method 300 starts at block 302. At block 304, data traffic determiner 124 of UE 101 determines a first logical channel with a lower priority is waiting for at least one data unit to be delivered from network entity 180. The data unit may be an RLC PDU, a control PDU, a status PDU, an acknowledgement message, or an indication message.

At block 306, data traffic determiner 124 may determine whether there is on-going data traffic, for example, data or control massages, over a second logical channel with a higher priority.

In an aspect, processor 103 and/or memory 105 of UE 101 may obtain a threshold value, for example, as described herein, the maximum number of PDU transmissions/retransmissions (e.g., MaxDAT). At block 308, processor 103 may determine whether the maximum number of transmissions/retransmissions of a PDU on the first logical channel with a lower priority has been attempted. The determination may be based on a comparison of the attempted number of transmissions/retransmissions of a PDU with the obtained threshold value (e.g., MaxDAT). For instance, processor 103 may execute Reset Management Component 120 to determine whether the attempted number of transmissions/retransmissions of a PDU satisfies the threshold value. In an aspect, the comparison at block 308 may include determining whether the attempted number of transmissions/retransmissions of a PDU equals to or is less than the threshold value. In another aspect, the comparison at block 308 may include determining whether the attempted number of transmissions/retransmissions of a PDU equals to or is greater than the threshold value.

In an aspect, method 300 may proceed to block 310 in response to trigger determiner 130 determining in block 308 that the maximum number of transmissions/retransmissions of a PDU on the first logical channel with a lower priority has been attempted. In other words, when method 300 is at block 310, the attempted number of transmissions/retransmissions of a PDU may satisfy the threshold value (e.g., MaxDAT). At block 310, RLC reset controller 126 may delay initiation of an RLC reset, which may, for example, provide additional opportunity to the first logical channel with a lower priority to receive the at least one data unit from network entity 180 which is not yet received. In an aspect, at block 310, RLC reset controller 126 may configure delay timer 132 (e.g., Last_Received_Timer) to delay initiation of an RLC reset. In another aspect, when delay timer 132 is configured and starts, UE 101 may continue retransmitting PDUs in uplink (e.g., requesting the status from peer RLC layer in the NW).

At block 312, data traffic determiner 124 and/or trigger determiner 130 may determine whether any downlink PDU has been scheduled to UE 101 within a predetermined time period. This predetermined time period may, for example, be set anywhere from zero (0) to hundreds of milliseconds. In an aspect, the predetermined time period may be associated with a state variable or delay timer 132.

In an aspect, method 300 may proceed from block 312 back to block 310 in response to trigger determiner 130 determining in block 312 that there is at least one downlink PDU being scheduled to UE 101 within a predetermined time period. In an aspect, if UE 101 receives at least one downlink PDU before delay timer 132 expires, RLC reset controller 126 may reset or restart delay timer 132. In other words, whenever a downlink PDU is received on any logical channel, delay timer 132 (e.g., Last_Received_Timer) is set or reset to zero (0). Then, in an aspect, method 300 may proceed from block 310 to block 312, and trigger determiner 130 may determine whether any downlink PDU has been scheduled to UE 101 before delay timer 132 expires.

In another aspect, method 300 may proceed from block 312 to block 316 in response to trigger determiner 130 determining in block 312 that there is no downlink PDU has been scheduled to UE 101 within a predetermined time period. In other words, when method 300 is at block 312, network entity 180 has not scheduled any downlink PDUs to UE 101 for more than a predetermined time period. As such, at block 316, processor 103 may permit RLC reset controller 126 to proceed with an RLC reset procedure and initiate an RLC reset. After RLC reset controller 126 proceeds to block 316 for initiating an RLC reset, method 300 may end at block 318.

Referring to FIG. 3B, in another operational aspect, UE 101 (in FIG. 1) may perform one aspect of method 300′ for triggering or delaying of an RLC reset procedure initiation. In an aspect, method 300′ starts at block 302. At block 304, the data traffic determiner 124 of UE 101 determines a first logical channel with a lower priority is waiting for at least one data unit to be delivered from network entity 180. The data unit may be an RLC PDU, a control PDU, a status PDU, an acknowledgement message, or an indication message.

At block 306, the data traffic determiner 124 may determine whether there is on-going data traffic, for example, data or control massages, over a second logical channel with a higher priority.

In an aspect, processor 103 and/or memory 105 of UE 101 may obtain a threshold value, for example, as described herein, the maximum number of PDU transmissions/retransmissions (e.g., MaxDAT). At block 308, processor 103 may determine whether the maximum number of transmissions/retransmissions of a PDU on the first logical channel with a lower priority has been attempted. The determination may be based on a comparison of the attempted number of transmissions/retransmissions of a PDU with the obtained threshold value (e.g., MaxDAT). For instance, processor 103 may execute Reset Management Component 120 to determine whether the attempted number of transmissions/retransmissions of a PDU satisfies the threshold value. In an aspect, the comparison at block 308 may include determining whether the attempted number of transmissions/retransmissions of a PDU equals to or is less than the threshold value. In another aspect, the comparison at block 308 may include determining whether the attempted number of transmissions/retransmissions of a PDU equals to or is greater than the threshold value.

In an aspect, method 300′ may proceed to block 310 in response to trigger determiner 130 determining in block 308 that the maximum number of transmissions/retransmissions of a PDU on the first logical channel with a lower priority has been attempted. In other words, when method 300′ is at block 310, the attempted number of transmissions/retransmissions of a PDU may satisfy the threshold value (e.g., MaxDAT). At block 310, RLC reset controller 126 may delay initiation of an RLC reset, which may, for example, provide additional opportunity to the first logical channel with a lower priority to receive the at least one data unit from network entity 180 which is not yet received.

At block 314, data traffic determiner 124 and/or trigger determiner 130 may determine that whether a third logical channel with a lower priority than the first logical channel has at least a data or control PDU to be received by UE 101. In another aspect, at block 314, data traffic determiner 124 and/or trigger determiner 130 may determine that whether a third logical channel with same priority as the first logical channel has at least a data or control PDU to be received by UE 101.

In another aspect, method 300′ may proceed from block 314 back to block 310 in response to trigger determiner 130 determining in block 314 that there is no downlink PDU (e.g., a data PDU or a control PDU) being scheduled to transmit to UE 101 (or being received by UE 101) on a third logical channel with a lower priority than (or the same as) the first logical channel. At block 310, RLC reset controller 126 may delay initiation of the RLC reset since the triggering condition for an RLC reset in block 314 has not been met.

In another aspect, method 300′ may proceed from block 314 to block 316 in response to trigger determiner 130 determining in block 314 that there is at least one downlink PDU (e.g., a data PDU or a control PDU) being scheduled to transmit to UE 101 (or has been received by UE 101) on a third logical channel with a lower priority than (or the same as) the first logical channel. In other words, when method 300′ is at block 314, network entity 180 has sent data or control messages on a same or lower priority logical channel than the first logical channel that has reached maximum transmissions/retransmissions (e.g., MaxDAT). As such, at block 316, processor 103 may permit RLC reset controller 126 to proceed with an RLC reset procedure and initiate an RLC reset. After RLC reset controller 126 proceeds to block 316 for initiating an RLC reset, method 300′ may end at block 318.

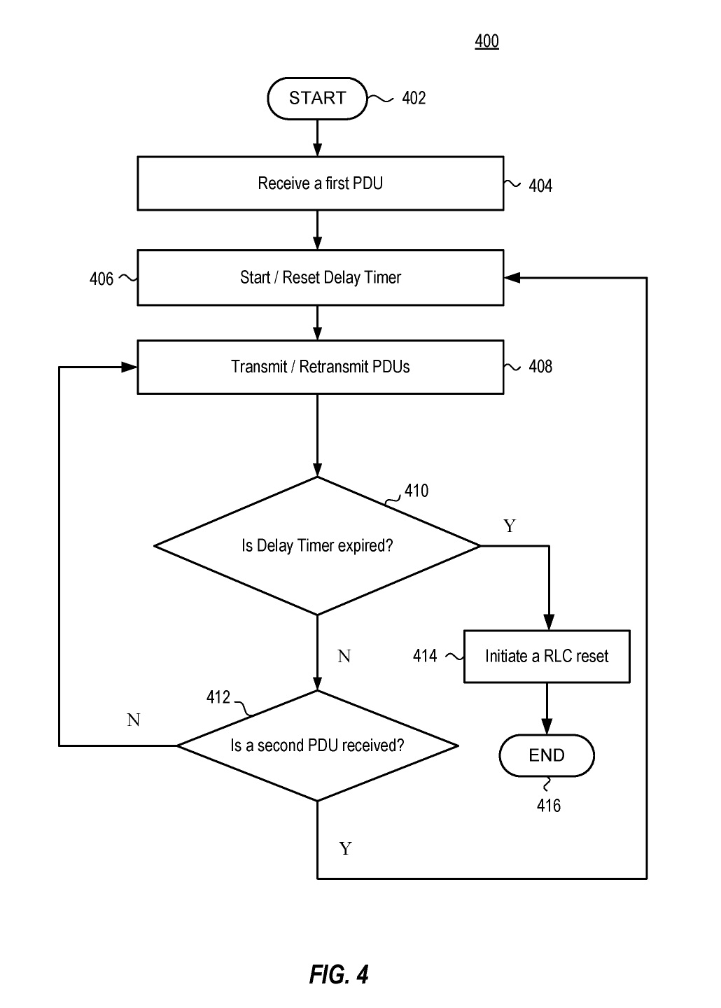

FIG. 4 is a flow chart of an example for delaying an RLC reset procedure using a delay timer as described herein. In an aspect, as discussed before, when a data unit (e.g., an ACK) is yet to be received over a lower priority logical channel and data traffic over a higher priority logical channel is detected, the triggering condition for an RLC reset is not met. Therefore, an RLC reset may not be initiated. Instead, the RLC reset may be delayed for a predetermined time period. In an aspect, the predetermined period of time is based on expiration of a timer. A value of the timer identifies a time since a last data unit (e.g., a PDU) was received over any downlink logical channel. The timer is reset or restarted whenever a data unit (e.g., a PDU) is received over any downlink logical channel. For example, a delay timer 132 may be associated with the predetermined time period and may be initiated or started at block 310 in FIG. 3A. In another example, the RLC reset controller 126 may delay initiation of an RLC reset when the trigger determiner 130 of UE 101 determines that the triggering condition for an RLC reset is not met, based on the determinations from data traffic determiner 124 which are described at blocks 202 and 204 in FIG. 2.

In an aspect, method 400 may start at block 402. At block 404, transceiver 106 of UE 101 may receive at least one PDU from network entity 180. The at least one first PDU may, for example, be received from network entity 180 on any logical channel. In response to the received PDU(s), at block 406, RLC reset controller 126 of UE 101 may start delay timer 132 (e.g., a state variable or Last_Received_Timer). This delay timer 132 may be, for example, configured having from zero (0) to hundreds of milliseconds.

At block 408, transceiver 106 may keep transmit or retransmit uplink PDUs. In an aspect, transceiver 106 may retransmit PDUs in uplink requesting the status from a peer RLC layer (e.g., an RLC layer at network entity 180). At block 410, RLC reset controller 126 may determine whether delay timer 132 has expired.

In an aspect, method 400 may proceed to block 412 if trigger determiner 130 determines that delay timer 132 has not expired. At block 412, trigger determiner 130 may determine whether another PDU is received by UE 101. In an aspect, if UE 101 receives at least another downlink PDU, RLC reset controller 126 may reset or restart delay timer 132 and proceed to block 406. In other words, whenever a downlink PDU is received on any logical channel, delay timer 132 (e.g., Last Received Timer) is set or reset to zero (0).

In another aspect, at block 412, if trigger determiner 130 determines that there is no other PDU received by UE 101, processor 103 may proceed to block 408 for continuing PDU transmissions or retransmissions. In another aspect, processor 103 may proceed to block 414 if delay timer 132 is determined expired by RLC reset controller 126. As such, at block 414, processor 103 may permit RLC reset controller 126 to proceed with an RLC reset procedure and initiate an RLC reset. In an aspect, after RLC reset controller 126 initiate an RLC reset at block 414, method 400 may end at block 416.

The apparatus may include additional components that perform each of the blocks of the algorithm in the aforementioned flowcharts of FIG. 2, FIG. 3A, FIG. 3B and FIG. 4. As such, each block in the aforementioned flowcharts of FIGS. 2-4 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, or the like.

Several aspects of a telecommunications system have been presented with reference to one or more wireless communication systems (e.g., W-CDMA system). As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communications, comprising:
determining, at a user equipment (UE), that at least one data unit to be received over a first logical channel is yet to be received by the UE;
determining, at the UE, that there is data traffic over a second logical channel, wherein the first logical channel having a lower priority than the second logical channel; and
delaying, at the UE, initiation of a radio link control (RLC) reset on a condition that the at least one data unit is yet to be received over the first logical channel and there is data traffic over the second logical channel.

2. The method of claim 1, wherein the at least one data unit is a protocol data unit (PDU) or an acknowledgement message.

3. The method of claim 1, wherein delaying initiation of the RLC reset includes:
retransmitting, by the UE, at least one PDU; and
awaiting, at the UE, the at least one data unit associated with the at least one retransmitted PDU.

4. The method of claim 3, further comprising:
determining that a maximum number of transmissions of the at least one PDU has been attempted by the UE on the first logical channel; and
identifying that the RLC reset initiation is to occur in response to determining that the maximum number of transmissions of the PDU has been attempted.

5. The method of claim 1, further comprising:
initiating the RLC reset on a condition that at least one data or control PDU has been scheduled for transmission to the UE or has been received by the UE over a third logical channel having a lower priority than the first logical channel.

6. The method of claim 1, further comprising:
initiating the RLC reset on a condition that the at least one data unit has not been scheduled for transmission to the UE for more than a predetermined time period.

7. The method of claim 6, further comprising:
determining the predetermined period of time based on expiration of a timer, wherein a value of the timer identifies a time since a last PDU was received by the UE over any logical channel, and wherein the timer is reset whenever a PDU is received by the UE over any logical channel.

8. The method of claim 1, further comprising performing the RLC reset in at least an RLC entity operating in acknowledged mode (AM).

9. An apparatus for wireless communications, comprising:
means for determining that at least one data unit to be received over a first logical channel is yet to be received;
means for determining that there is data traffic over a second logical channel, wherein the first logical channel having a lower priority than the second logical channel; and
means for delaying initiation of a radio link control (RLC) reset on a condition that the at least one data unit is yet to be received over the first logical channel and there is data traffic over the second logical channel.

10. The apparatus of claim 9, wherein the at least one data unit is a protocol data unit (PDU) or an acknowledgement message.

11. The apparatus of claim 9, wherein delaying initiation of the RLC reset includes:
means for retransmitting at least one PDU; and
means for awaiting the at least one data unit associated with the at least one retransmitted PDU.

12. The apparatus of claim 9, further comprising:
means for determining that a maximum number of transmissions of the at least one PDU has been attempted on the first logical channel; and
means for identifying that the RLC reset initiation is to occur in response to determining that the maximum number of transmissions of the PDU has been attempted.

13. The apparatus of claim 9, further comprising:
means for initiating the RLC reset on a condition that the at least one data unit has not been scheduled for transmission to the apparatus for more than a predetermined time period.

14. The apparatus of claim 9, further comprising:
means for initiating the RLC reset on a condition that at least one data or control PDU has been scheduled for transmission to the apparatus or has been received by the apparatus over a third logical channel having a lower priority than the first logical channel.

15. The apparatus of claim 9, further comprising:
means for determining the predetermined period of time based on expiration of a timer, wherein a value of the timer identifies a time since a last PDU was received by the apparatus over any logical channel, and wherein the timer is reset whenever a PDU is received by the apparatus over any logical channel.

16. The apparatus of claim 9, further comprising:
means for performing the RLC reset in at least an RLC entity operating in acknowledged mode (AM).

17. An apparatus for wireless communications, comprising:
a memory configured to store instructions; and
at least one processor coupled to the memory, the at least one processor and the memory are configured to execute the instructions to:
determine that at least one data unit to be received over a first logical channel is yet to be received;
determine that there is data traffic over a second logical channel, wherein the first logical channel having a lower priority than the second logical channel; and
delay initiation of a radio link control (RLC) reset on a condition that the at least one data unit is yet to be received over the first logical channel and there is data traffic over the second logical channel.

18. The apparatus of claim 17, wherein the at least one data unit is a protocol data unit (PDU) or an acknowledgement message.

19. The apparatus of claim 17, wherein the at least one processor and the memory are further configured to execute the instructions to:
retransmit at least one PDU; and
await the at least one data unit associated with the at least one retransmitted PDU.

20. The apparatus of claim 17, wherein the at least one processor and the memory are further configured to execute the instructions to:
determine that a maximum number of transmissions of the at least one PDU has been attempted on the first logical channel; and
identify that the RLC reset initiation is to occur in response to determining that the maximum number of transmissions of the PDU has been attempted.

21. The apparatus of claim 17, wherein the at least one processor and the memory are further configured to execute the instructions to:
initiate the RLC reset on a condition that the at least one data unit has not been scheduled for transmission to the apparatus for more than a predetermined time period.

22. The apparatus of claim 17, wherein the at least one processor and the memory are further configured to execute the instructions to:
initiate the RLC reset on a condition that at least one data or control PDU has been scheduled for transmission to the apparatus or has been received by the apparatus over a third logical channel having a lower priority than the first logical channel.

23. The apparatus of claim 17, wherein the at least one processor and the memory are further configured to execute the instructions to:
determine the predetermined period of time based on expiration of a timer, wherein a value of the timer identifies a time since a last PDU was received by the apparatus over any logical channel, and wherein the timer is reset whenever a PDU is received by the apparatus over any logical channel.

24. The apparatus of claim 17, wherein the at least one processor and the memory are further configured to execute the instructions to:
perform the RLC reset in at least an RLC entity operating in acknowledged mode (AM).

25. A computer-readable medium storing computer executable code, comprising code to:
determine that at least one data unit to be received over a first logical channel is yet to be received;
determine that there is data traffic over a second logical channel, wherein the first logical channel having a lower priority than the second logical channel; and
delay initiation of a radio link control (RLC) reset on a condition that the at least one data unit is yet to be received over the first logical channel and there is data traffic over the second logical channel.

26. The computer-readable medium of claim 25, wherein the at least one data unit is a protocol data unit (PDU) or an acknowledgement message.

27. The computer-readable medium of claim 25, further comprising code to:
retransmit at least one PDU; and
await the at least one data unit associated with the at least one retransmitted PDU.

28. The computer-readable medium of claim 25, further comprising code to:
determine that a maximum number of transmissions of the at least one PDU has been attempted on the first logical channel; and
identify that the RLC reset initiation is to occur in response to determining that the maximum number of transmissions of the PDU has been attempted.

29. The computer-readable medium of claim 25, further comprising code to:
initiate the RLC reset on a condition that:
at least one data unit has not been scheduled for downlink transmission for more than a predetermined time period; or
at least one data or control PDU has been scheduled for downlink transmission or has been received over a third logical channel having a lower priority than the first logical channel.

30. The computer-readable medium of claim 25, further comprising code to:
determine the predetermined period of time based on expiration of a timer, wherein a value of the timer identifies a time since a last downlink PDU was received over any logical channel, and wherein the timer is reset whenever a downlink PDU is received over any logical channel.
